(19) United States
(12) Patent Application Publication
(10) Pub. No.: US 2026/0189151 A1
(43) Pub. Date: Jul. 2, 2026

(54) RESONANT POWER CONVERSION SYSTEMS AND METHODS

(71) Applicant: B. G. NEGEV TECHNOLOGIES AND APPLICATIONS LTD., AT BEN-GURION UNIVERSITY, Beer Sheva (IL)

(72) Inventors: Alon Kuperman, Beer Sheva (IL); Andrey Vulfovich, Beer Sheva (IL)

(73) Assignee: B.G. Negev Technologies and Applications Ltd., Beer Sheva (IL)

(21) Appl. No.: 18/817,099

(22) PCT Filed: Feb. 27, 2023
(86) PCT No.: PCT/IB2023/051814

§ 371 Date: Aug. 27, 2024

Related U.S. Application Data
(60) Provisional application No. 63/314,415, filed on Feb. 27, 2022.

(51) Int. Cl. H02M 5/27; B60L 53/122; B60L 53/62; H02M 1/12; H02M 5/451

(52) U.S. Cl. CPC H02M 5/27; B60L 53/122; B60L 53/62; H02M 1/12; H02M 5/451

(57) ABSTRACT

Embodiments pertain to a resonant power conversion system comprising switching circuitry configured to convert a low frequency AC power signal to a high frequency AC power signal, power conversion circuitry electrically connected in parallel with a source of the low frequency AC power signal and additionally connected in parallel with a consumer of the high frequency AC power signal. The source and the consumer may be electrically connected in series, and a low-pass filter may be serially connected between an output of the switching circuitry and the source of low frequency AC power signal.

### CROSS-REFERENCE TO RELATED APPLICATIONS

This application claims priority and/or benefit from U.S. patent application 63/314,415, filed Feb. 27, 2022, titled “Single stage three-phase AC-AC converter with power factor correction for driving a wireless power transfer system”, which application is incorporated herein by reference in its entirety.

### TECHNICAL FIELD

The present disclosure relates to systems and methods for wireless power transfer in general.

### BACKGROUND

High-frequency resonant power conversion technology is widely used for transfer of power between a source, for example, the electrical grid, and a load, for example, an electric vehicle battery, and vice-versa. Some applications include electric vehicle charging (wired and wireless), wireless power transfer (both inductive and capacitive), inductive heating, and resonant power supply, among numerous other applications. A typical resonant power conversion system may include at least two conversion stages linked via a DC bus. The first conversion stage is inserted between the source and the DC bus while the second conversion stage is inserted between the DC bus and a resonant network (eventually interfacing the load). The functionality of the first conversion stage is typically focused on regulating the DC bus average voltage to a certain reference value while exchanging a predetermined shaped-current (typically low frequency, e.g. 50 Hz, 60 Hz, 400 Hz) with the source. The functionality of the second conversion stage is typically focused on regulating load voltage and/or current/and/or power by converting the DC bus voltage to a high-frequency (typically several kHz to several MHz) output. Both stages are typically connected in series, therefore their ratings are generally equal at least to the power exchanged by the source and the load. Consequently, two actively controlled full-rating power conversion stages are utilized.

A block diagram of a high-frequency resonant power conversion system 10 is shown in FIG. 1. The system 10, as shown, includes a low-frequency (LF) AC/DC conversion stage 12 connected on to a 3-phase AC source 14 (e.g., electrical grid) through a LF AC bus 16, and through a DC bus 18 to a high frequency (HF) DC/AC conversion stage 20. Also included is a resonant network with load interfacing circuitry 22 which connects to the load 24 and is connected to the HF DC/AC conversion stage 20 through a HF AC bus 26. The load 24, may be, for example, an electric vehicle battery. Both the LF conversion stage 12 and the HF conversion stage 20 are generally implemented by switching power converters so that the currents of the LF AC bus 16 contain source-frequency and switching-frequency components while the currents of HF AC bus 24 mainly contain switching-frequency components residing around the resonant frequency or frequencies.

A capacitance of the DC bus 18 may be split into two or more partial capacitances, for example, an example capacitance shown by capacitor 28. Moreover, the source 14 may be DC, AC, single-phase or multi-phase. Likewise, resonant network and other load-interfacing circuitry 22 may be single-phase or multi-phase.

The low-frequency AC/DC conversion stage 12 generally includes inductive filters 30 shown as LA, LB and LC (which may be pure inductive, inductive-capacitive or inductive-capacitive-inductive), at the source side to suppress switching harmonics, as shown in the system 10A of FIG. 2.

Referring to FIG. 2, given grid voltages of the form (phase R is taken as an example)

$${v}_{R} ( t ) = {V}_{M} sin {ω}_{G} t , \qquad ( 1 )$$

where V_{M} and ω_{G} denote magnitude and frequency, respectively, the corresponding grid-side converter voltage includes grid-frequency (V_{G}) and switching frequency (V_{S1}) components, described by

$${v}_{A} ( t ) = {\underbrace{{V}_{MA} sin ( {ω}_{G} t + ϕ )}}_{{v}_{G}} + {\underbrace{{\sum }_{n = 1}^{∞} {V}_{n s A} sin ( n {ω}_{S 1} t + {α}_{n} )} ,}_{{v}_{S 1}} \qquad ( 2 )$$

where V_{MA} and φ denote magnitude and phase of the grid-frequency component, ω_{S1}>>ω_{G} represents the switching frequency, and n, V_{nsA}, αₙ represents the switching frequency harmonic number, magnitude and phase of the LF DC/AC conversion stage 16, respectively. It is noted that V_{MA}, φ, V_{1sA} and α₁ are controllable in general. Consequently, the current exchanged between the LF AC/DC conversion stage 16 and the grid 14 is given by

$$\begin{matrix}{i}_{R} ( t ) = \frac{{V}_{MA} sin ( {ω}_{G} t + ϕ - \frac{π}{2} ) - {V}_{M} sin ( {ω}_{G} t - \frac{π}{2} )}{{ω}_{G} {L}_{A}} + {\sum }_{n - 1}^{∞} \frac{{V}_{nsA}}{n {ω}_{S} {L}_{A}} sin ( n {ω}_{S 1} t + {α}_{n} - \frac{π}{2} ) \\ = {I}_{M} sin ( {ω}_{G} t + β ) + {\sum }_{n - 1}^{∞} {I}_{nsA} sin ( n {ω}_{S 1} t + {α}_{n} - \frac{π}{2} ) .\end{matrix} \qquad ( 3 )$$

It may be appreciated that the values of I_{M}, β depend on V_{MA}, φ and may be independently controlled. Moreover, the value of ω_{S}L_{A} is generally selected such that I_{nsA}<I_{M} (rather than altering V_{1sA} and α₁) so that switching harmonic content of the current remains below certain predetermined bound (ω_{S1}>>ω_{G} is usually selected). The inductive filters LA, LB and LC are low-pass filters, passing grid-frequency component while blocking switching-frequency components. The output voltage of the HF DC/AC conversion stage 20 is generally given by the switching frequency (V_{S2}) component only (phase X is taken as an example)

$${v}_{X} ( t ) = {\underbrace{{\sum }_{n - 1}^{∞} {V}_{nsX} sin ( n {π}_{S 2} t + {θ}_{n} )}}_{{v}_{S 2}} , \qquad ( 4 )$$

where ω_{S2}>>ω_{G} represents the switching frequency of the HF DC/AC conversion stage (i.e. ω_{S2} resides in the vicinity of one of the resonant network resonances) and n, V_{nsX}, ϑₙ signify switching frequency harmonic number, magnitude and phase of the high-frequency DC/AC conversion stage 20, respectively. V_{1sX} and/or Ψ_{S2} and/or α₁ may be controlled to regulate load voltage and/or current and/or power. Due to resonant network 22 band-pass properties, current exchanged by the HF power conversion stage 20 and the resonant network approximately contains the first harmonic only,

$${i}_{X} ( t ) = \frac{{V}_{1 , sX}}{{Z}_{1}} sin ( {ω}_{S 2} t + {θ}_{1} - arg ( {Z}_{1} ) ) = {I}_{1 sX} sin ( {ω}_{S 2} t + {δ}_{n} ) , \qquad ( 5 )$$

where Z₁ and arg(Z₁) denote the impedance “seen” by the high-frequency power conversion stage at frequency ω_{S2}. The current exchanged between resonant network 22 and the HF power conversion stage 20 is determined by V_{1sX} and/or ω_{S2} and/or α₁ (i.e. first harmonic related variables only).

The description above is presented as a general overview of related art in this field and should not be construed as an admission that any of the information it contains constitutes prior art against the present patent application.

### BRIEF DESCRIPTION OF THE DRAWINGS

The figures illustrate generally, by way of example, but not by way of limitation, various embodiments discussed in the present document.

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear. The number of elements shown in the Figures should by no means be construed as limiting and is for illustrative purposes only. The figures are listed below.

FIG. 1 schematically illustrates an example two-stage resonant power conversion system.

FIG. 2 schematically illustrates an example two-stage resonant power conversion system including line inductor filters on the source side.

FIG. 3 schematically illustrates an example three-phase resonant power conversion system including a single-stage resonant power conversion device, according to an embodiment.

FIG. 4 schematically illustrates a single-phase equivalent circuit of the topography shown in FIG. 3 for a phase R, according to an embodiment.

FIG. 5 schematically illustrates an example a single-stage resonant power conversion system where a resonant network and the load interfacing circuitry are single-phase and the AC source is three-phase, interconnected according to an embodiment.

FIG. 6 schematically illustrates another example single-stage resonant power conversion system where a resonant network and the load interfacing circuitry are single-phase and the AC source is three-phase, interconnected according to an embodiment.

FIG. 7 is a schematic block diagram illustration of a single-stage resonant power conversion system, according to an embodiment.

### DETAILED DESCRIPTION

Some embodiments pertain to the replacement of existing resonant power conversion systems integrating two or more actively controlled, full-rating series-connected power conversion stages by single-stage resonant power conversion systems which use less components, providing, for example, for increased efficiency, lower complexity, higher reliability, lighter physical weight, and/or reduced production and operational costs.

In some embodiments, the power conversion systems may include a single stage (e.g., single-phase, two-phase or three phase) AC-AC converter with power factor correction configured to be connected in parallel to a relatively low frequency (LF) three-phase AC source, for example the electrical grid, and also configured to be connected in parallel to a relatively high frequency (HF) resonant network connected to the load. The load may optionally be, but not limited to, an electric car battery.

The resonant network may be serially connected to the AC source and may include load interfacing circuitry suitable to allow connection of the network to the load. By connecting the AC-AC converter in parallel to the serially connected LF AC source and HF resonant network, a three-phase resonant network may be connected directly to the three phases of the AC source. Optionally, a single-phase resonant network may be connected to the three-phase AC source by sharing one or two phases between the AC source and the resonant network.

It may be appreciated that the parallel connection of the AC-AC converter to the serially connected AC source and resonant network may be facilitated by exploiting the line impedance of the AC bus on the side of the AC source which includes an inductance which prevents the HF AC output from the AC-AC converter to flow through the AC bus back to the AC source. Optionally, line inductors may be included in the AC-AC converter to enhance the HF filtering provided by the line impedance of the AC bus on the side of the AC source. The parallel connection may further facilitated by exploiting the LF filtering characteristics of the resonant network which allows the HF output of the AC-AC converter, which is (substantially) at the resonant frequency of the resonant circuit, to pass while filtering the LF AC source signal.

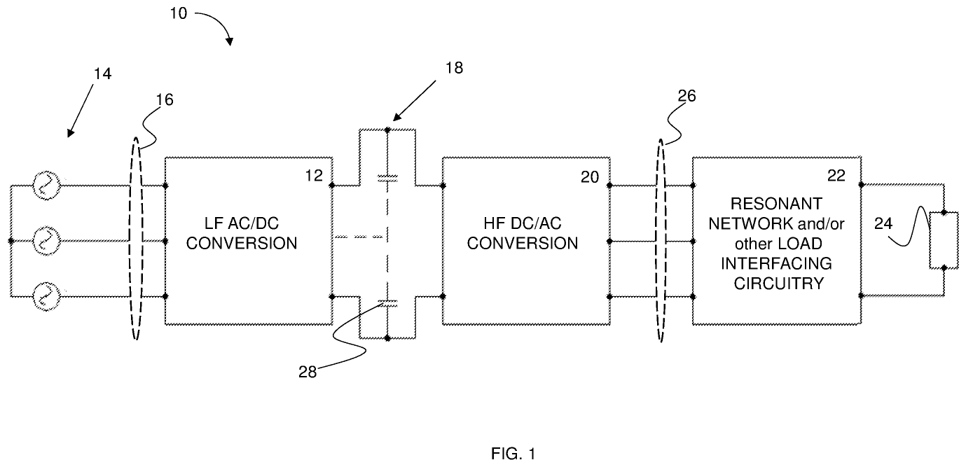

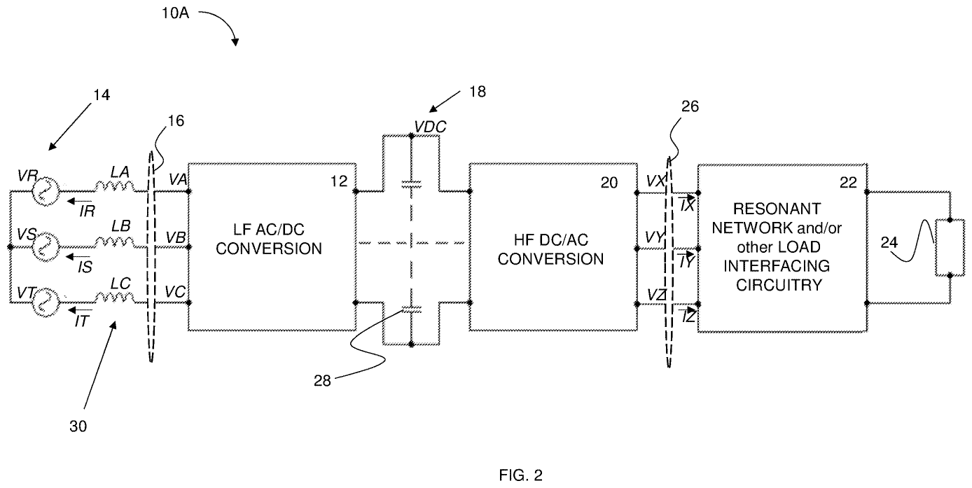

As previously discussed with regards to FIGS. 1 and 2, two actively controlled full-rating series-connected power conversion stages are generally utilized in resonant power conversion systems. Nevertheless, as also previously mentioned, it is particularly advantageous to integrate the functionalities of both stages into a single conversion stage. The integration may be made possible by selecting the switching frequencies of both power stages to be equal, i.e.

$${ω}_{S 1} = {ω}_{S 2} = {ω}_{S} , \qquad ( 6 )$$

such that the switching frequency components of v_{A}(t) and v_{X}(t) may be given by

$${v}_{S 1} ( t ) = {\sum }_{n = 1}^{∞} {V}_{nsA} sin ( n {ω}_{S} t + {α}_{n} ) , {v}_{S 2} ( t ) = {\sum }_{n = 1}^{∞} {V}_{nsX} sin ( n {ω}_{s} t + {θ}_{n} ) . \qquad ( 7 )$$

It is noted that the values of V_{1sA} and α₁ are not altered by the LF AC/DC conversion stage since their values may be considered to have little or negligible effect on its operation. Consequently, it may be possible to set

$${V}_{1 sA} = {V}_{1 sX} , {α}_{1} = {θ}_{1} \qquad ( 8 )$$

as long as the switching harmonic content of the current exchanged by the grid and the LF AC/DC conversion stage remains below a certain threshold, which may be set by certain power-quality related standard. In some embodiments, the threshold may be a predetermined threshold or a threshold that is set adaptively, e.g., depending on system characteristics.

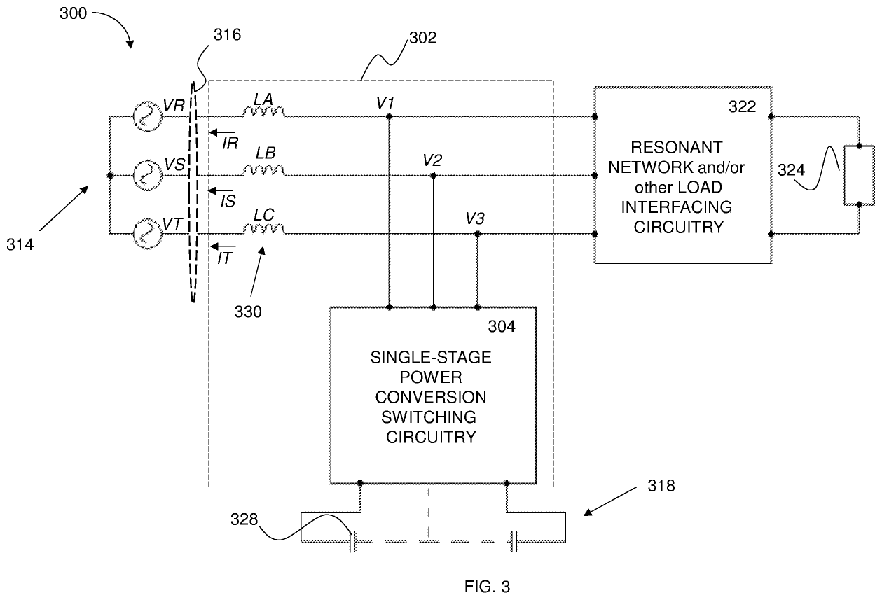

Maintaining the conditions described by equations (6) and (8), the switching frequency components of v_{A}(t) and v_{X}(t) are equal, despite v_{A}(t) including low-frequency component and v_{X}(t) not. Nevertheless, the current exchanged between the resonant network and the HF DC/AC power conversion stage is imposed by V_{1sX} and/or ω_{S2} and/or α₁ and the resonant network band-pass properties. Therefore, components residing around ω_{G}<<ω_{S} may be considered to have negligible influence on i_{X}(t), and applying v_{A}(t) while maintaining the conditions described by equations (6) and (8) to the resonant input network, would not alter i_{X}(t) in equation (5). Consequently, v_{A}(t) and v_{X}(t) may be integrated by combining the LF and HF power conversion stages into a single conversion stage, as schematically shown in FIG. 3, described herein below.

Reference is now made to FIG. 3, which schematically illustrates an example resonant power conversion system 300 including a single-stage resonant power conversion device 302, according to an embodiment. The single-stage resonant power conversion device 302 is connected in parallel to a 3-phase AC source 314 (e.g., electrical grid) through an AC bus 316, and also in parallel to a resonant network and load interfacing circuitry 322. The resonant network and load interfacing circuitry 322 is serially connected to the 3-phase AC source 314, and is also connected to a load 324. The load 324, may be, for example, an electric vehicle battery.

The single-stage resonant power conversion device 302 includes single-stage (also: unified) power conversion switching circuitry 304 which connects to each phase of the 3-phase AC source 314, and also includes (e.g., inductive) filters 330 connected to each phase of the 3-phase AC source, as shown by inductors LA, LB, and LC. The filters 330, which may be pure inductive, inductive-capacitive or inductive-capacitive-inductive, are installed on the source side of the 3-phase AC source to suppress switching harmonics.

The single-stage power conversion switching circuitry 304 may include switching-frequency components which operate around the frequency of the 3-phase AC source 314, and switching-frequency components residing around the resonant frequency or frequencies of the resonant network and load interfacing circuitry 322.

A capacitance of the DC bus 318 may be split into two or more partial capacitances, for example, an example capacitance shown by capacitor 328.

The output voltage of the single-stage resonant power conversion device 302 may be given by V1, V2, and V3 for the 3-phases, respectively. It may be appreciated that the output voltage V1 for phase 1 may be expressed by the following equation:

$${v}_{1} ( t ) = {\underbrace{{V}_{MA} sin ( {ω}_{G} t + ϕ )}}_{{v}_{G}} + {\underbrace{{\sum }_{n = 1}^{∞} {V}_{nsX} sin ( n {ω}_{S} t + {θ}_{n )}}}_{{v}_{S 2}} . \qquad ( 9 )$$

Consequently, the current exchanged between the single-stage resonant power conversion device 302 and the 3-phase AC source 314 may be given by equation (3) while the current exchanged between single-stage resonant power conversion device and the resonant network including load interfacing circuitry may be given by equation (5).

As previously discussed above, the filters 330 prevent high frequency currents produced by the single-stage power conversion switching circuitry 304 from flowing in a direction of the 3-phase AC source, and the low frequency currents from the 3-phase AC source 314 and from the single-stage power conversion switching circuitry 304 are prevented from flowing into the resonant network and load interfacing 322, and from reaching the load 324, by the intrinsic behavior of the resonant network which acts as a high pass filter and only allows high frequency currents to flow through.

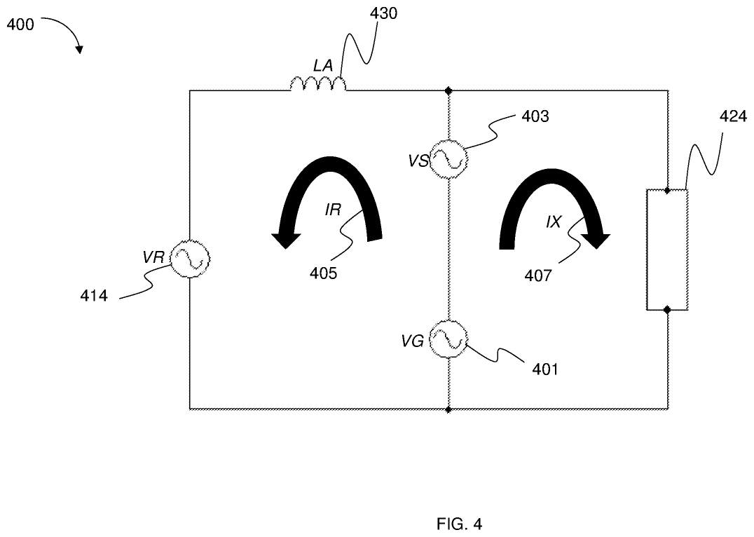

Reference is now made to FIG. 4 which schematically illustrates an equivalent circuit 400 of the topography shown in FIG. 3 for phase R, according to an embodiment. Equivalent circuit 400 includes an AC source VR 414 representative of the voltage and frequency of phase R, an equivalent AC voltage source VG 401 representative of the voltage and switching frequency associated with the grid side of the single-stage resonant power conversion stage, an equivalent AC voltage source VS 403 representative of the voltage and switching frequency associated with the resonant network and load side of the single-stage resonant power conversion stage, inductor filter LA 430 on the grid side of the single-stage resonant power conversion stage, and a reflected load 424. The current IR 405 is the low frequency current output by the single-stage power conversion switching circuitry and flowing through the inductor filter LA 430 on the grid side, and IX 407 is the high frequency current output by the single-stage power conversion switching circuitry and flowing through the resonant network and interfacing load circuitry to the load.

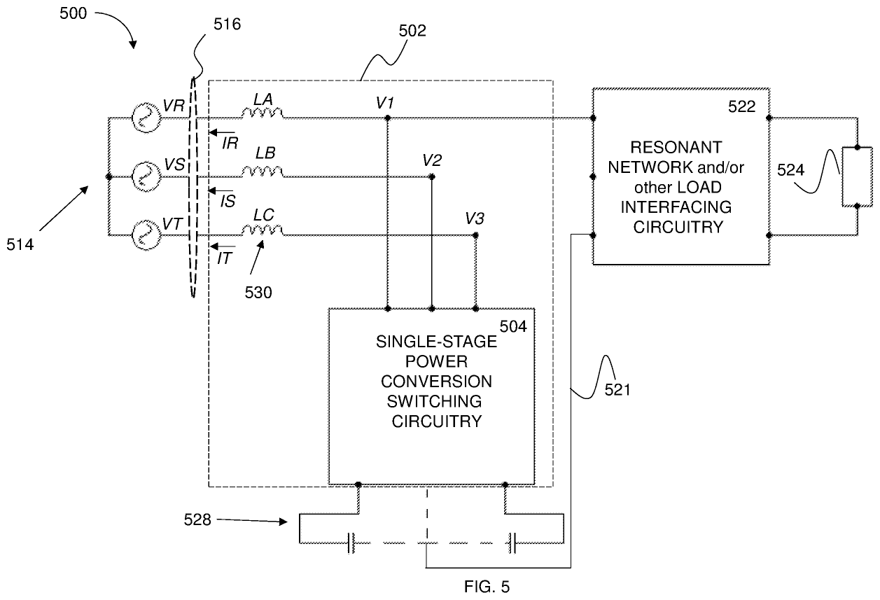

It is noted that the number of AC source phases and the number of resonant network phases do not have to be equal. For example, FIG. 5 schematically illustrates a single-stage resonant power conversion system 500 where a resonant network and the load interfacing circuitry 522 are single-phase while the AC source 514 is 3-phase, interconnected or operatively coupled with each other, according to an embodiment.

As shown in FIG. 5, a single-stage or unified power conversion switching circuitry 504 is connected in parallel to the 3-phase AC source 514 and to the single-phase resonant network and load interfacing circuitry 522. A connection 521 from the middle point of a DC bus 528 acts as a second input to the resonant network and interfacing circuitry 522 in addition to a single phase connection from the 3-phase AC source 514, as seen from phase R. As previously described with reference to FIG. 3, the single-stage resonant power conversion device 502 includes (e.g., inductive) filters 530, LA, LB, and LC connecting to each phase of the 3-phase AC source 514 through AC bus 516, and a load 524 which connects to the output of the resonant network and load interfacing circuitry 522.

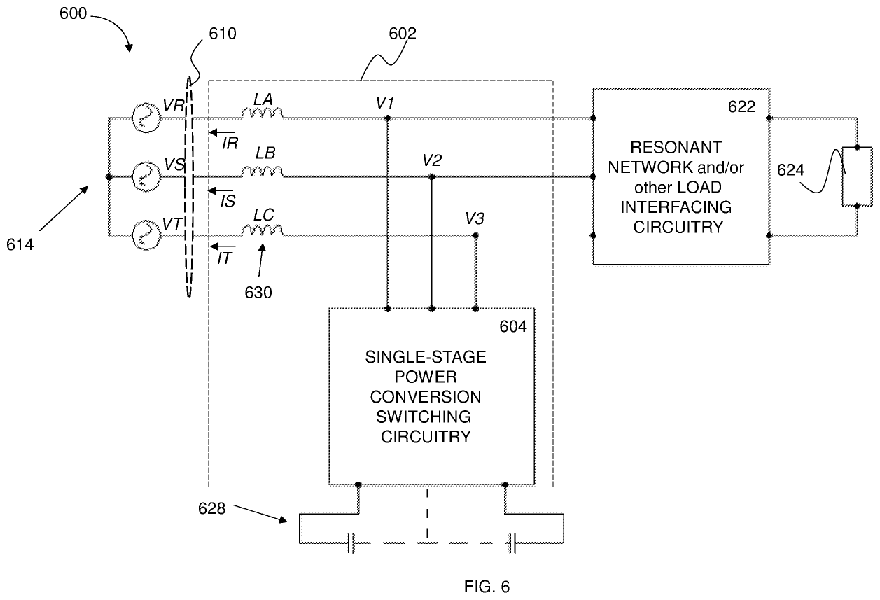

In another example, FIG. 6 schematically illustrates a single-stage resonant power conversion system 600 where a resonant network and the load interfacing circuitry 622 are single-phase and the AC source 614 is 3-phase, interconnected or operably coupled with each other, according to an embodiment of.

As shown in FIG. 6, a single-stage power conversion switching circuitry 604 is connected in parallel to the 3-phase AC source 614 and to the single-phase resonant network and load interfacing circuitry 622. A two-phase connection is made between the 3-phase AC source 614 and the resonant network and interfacing circuitry 622, as seen from phases R and S. As previously described with reference to FIG. 3, the single-stage resonant power conversion device 602 includes (e.g., inductive) filters 630, LA, LB, and LC connecting to each phase of the 3-phase AC source 614 through AC bus 616, and a load 624 which connects to the output of the resonant network and load interfacing circuitry 622.

It is further noted that power may similarly be exchanged between a single-phase AC source and a three-phase resonant network. Furthermore, the person skilled in the art may clearly appreciate that other topographies may be possible.

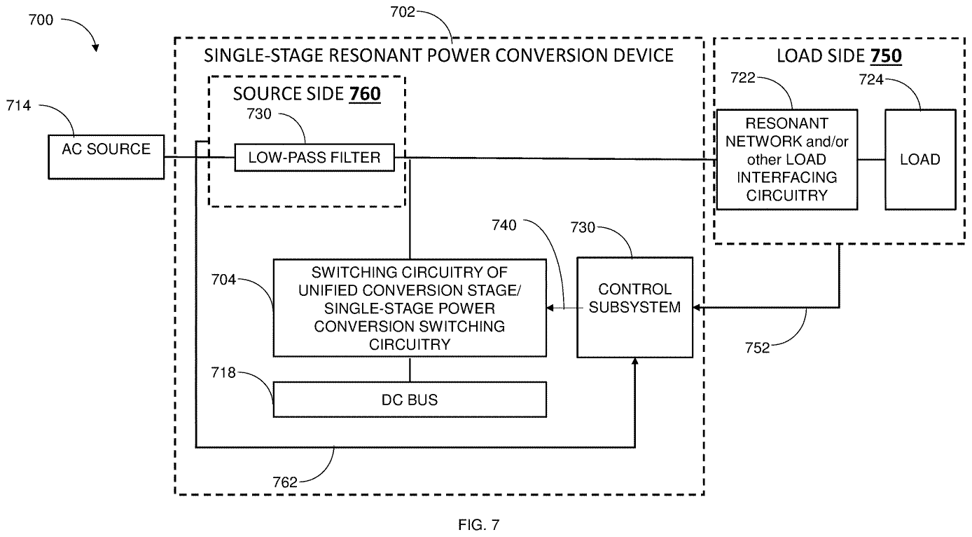

Further reference is made to FIG. 7. Generally, a power conversion system 700 may have a topology employing a single-stage resonant power conversion stage or device 702, according to an embodiment. The single-stage resonant power conversion device 702 may be connected in parallel to an AC source 714 (e.g., electrical grid) through an AC bus (not shown), and also in parallel to a resonant network and load interfacing circuitry 722. The resonant network and load interfacing circuitry 722 is serially connected to AC source 714, and is also connectable to a load 724. The load 724, may be, for example, an electric vehicle battery.

The single-stage resonant power conversion device 702 includes single-stage (also: unified) power conversion switching circuitry 704 which connects to each phase of 3-phase AC source 714, and also includes (e.g., inductive) one or more low-pass filters 730 connected to each phase of the AC source. In some examples, the filters 730 may be pure inductive, inductive-capacitive or inductive-capacitive-inductive, are installed on the source side of the AC source to suppress switching harmonics.

The single-stage power conversion switching circuitry 704 may include switching-frequency components which operate around the frequency of AC source 714, and switching-frequency components residing around the resonant frequency or frequencies of the resonant network and load interfacing circuitry 722. Unified conversion stage device

A capacitance of a DC bus 718 may be split into two or more partial capacitances, for example, an example capacitance shown by capacitor 728.

As schematically shown in FIG. 7, system 700 may include a controller 740 for automatically or semi-automatically controlling one or more operating parameter of the system, for example:

A) to regulate or adapt the load voltage and/or current and/or power to a certain reference value (constant or time-varying);

B) to impose certain shape of source-side currents (for example, but not limited to sinusoidal shape and same frequency and phase as source voltage(s).

In some embodiments, a controller may for example be implemented or replaced by one or more processors and memories. processor executing instructions stored in the memory resulting in processes, steps, and/or methods described herein.

In order to adapt the load voltage and/or current and/or power to a certain reference value, information regarding load voltage and/or current and/or power may be transmitted using load-side measurements to controller 740, optionally residing at source side. The information may be transmitted through wired and/or wireless communication links. Load side measurements may be obtained from resonant network 722 and/or from load 724 and provided to controller 740.

Alternatively, information regarding load voltage and/or current and/or power may be estimated using measurements received via link 762 from source-side 760 only, e.g., without requiring the need for feedback received via link 752 from load-side 750.

In either cases, system power balance must be maintained by keeping the average value of DC bus voltage regulated to a certain reference value (constant or time-varying).

To determine the estimates without feedback from load-side measurements, information regarding source voltage/s and/or current/s obtained by appropriate measurements, is provided to controller 740.

Based on the load-side measurement, known reference value of load voltage and/or current and/or power, as well as based on certain reference value of the average DC bus voltage, the controller estimates a required switching sequence of a single-stage power conversion switching circuitry. Source side 760 for example pertains to outputs of an AC Bus (not shown), outputs of low-pass filter 730, and/or the like. One example of obtaining such estimate is described in: Trachtenberg, O.; Kuperman, A. Quadrature Demodulator-Assisted Estimation of Load Voltage and Resistance Based on Primary-Side Information of a Wireless Power Transfer Link. Electronics 2021, 10, 1858. https://doi.org/10.3390/electronics10151858, incorporated herein by reference in its entirety.

### Additional Examples

Example 1 concerns a resonant power conversion system comprising:
switching circuitry configured to convert a low frequency AC power signal to a high frequency AC power signal,
power conversion circuitry and/or a power conversion device, electrically connected in parallel with a source of the low frequency AC power signal and additionally connected in parallel with a consumer of the high frequency AC power signal, wherein the source and the consumer are electrically connected in series; and
a low-pass filter serially connected between an output of the switching circuitry and the source of low frequency AC power signal.

Example 2 includes the subject of example 1 and, optionally, wherein the source of the low frequency AC power signal comprises a single-phase, two-phase or a three phase AC source.

Example 3 includes the subject matter of any one or more of the examples 1 to 2 and, optionally, wherein the source of the low frequency AC power signal comprises an electric grid.

Example 4 includes the subject matter of any one or more of the examples 1 to 3 and, optionally, wherein the consumer of the high frequency AP power signal comprises a resonant network.

Example 5 includes the subject matter of Example 4 and, optionally, a load connected to the resonant network.

Example 6 includes the subject matter of example 5 and, optionally, wherein the load comprises an electric vehicle battery.

Example 7 includes the subject matter of any one or more of the examples 1 to 6 and, optionally, wherein the serial connection between the source and the consumer comprises a single-phase, two-phase, or a three-phase electrical connection.

Example 8 includes the subject matter of any one or more of the examples 1 to 7 and, optionally, wherein the low-pass filter comprises an inductive filter.

Example 9 concerns a method of generating high frequency resonant AC power, the method comprising:
connecting switching circuitry configured to convert a low frequency AC power signal to a high frequency AC power signal in parallel with a source of the low frequency AC power signal;
connecting the switching circuitry in parallel with a consumer of the high frequency AC power signal;
connecting the source and the consumer in series; and
connecting a low-pass filter between an output of the switching circuitry and the source of low frequency AC power signal.

Example 10 includes the subject matter of example 9 and, optionally, using a three phase AC source as the source of the low frequency AC power signal.

Example 11 includes the subject matter of examples 9 and/or 10 and, optionally, using an electric grid as the source of the low frequency AC power signal.

Example 12 includes the subject matter of any one or more of the examples 9 to 11 and, optionally, using a resonant network as the consumer.

Example 13 includes the subject matter of example 12 and, optionally, comprising connecting a load to the resonant network.

Example 14 includes the subject matter of example 13 and, optionally, using an electric vehicle battery as the load.

Example 15 includes the subject matter of any one or more of the examples 9 to 14 and, optionally, comprising connecting a three-phase electrical connection between the source and the consumer.

Example 16 includes the subject matter of any one or more of the examples 9 to 14 and, optionally, connecting a two-phase electrical connection between the source and the consumer.

Example 17 includes the subject matter of any one or more of the examples 9 to 14 and, optionally, connecting a single-phase electrical connection between the source and the consumer.

Example 18 includes the subject matter of any one or more of the examples 9 to 17 and, optionally, comprising using an inductive filter as the low-pass filter.

In examples, the system includes a controller for controlling one or more parameter values relating to the resonant power conversion system.

In some examples, the controlling is performed based on measured load-side parameter values and/or based on measured source-side parameter values.

According to some embodiments, a memory may include one or more types of computer-readable storage media. A memory may include transactional memory and/or long-term storage memory facilities and may function as file storage, document storage, program storage, or as a working memory. The latter may for example be in the form of a static random access memory (SRAM), dynamic random access memory (DRAM), read-only memory (ROM), cache and/or flash memory. As working memory, temporally-based and/or non-temporally based instructions may be included. As long-term memory, a volatile or non-volatile computer storage medium, a hard disk drive, a solid state drive, a magnetic storage medium, a flash memory and/or other storage facility may be employed. A hardware memory facility may for example store a fixed information set (e.g., software code) including, but not limited to, a file, program, application, source code, object code, data, and/or the like.

The term “processor”, as used herein, may additionally or alternatively refer to a controller. A processor may be implemented by various types of processor devices and/or processor architectures including, for example, embedded processors, communication processors, graphics processing unit (GPU)-accelerated computing, soft-core processors and/or general purpose processors.

The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

Any digital computer system, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may be directly loadable into an internal memory of a digital computer, comprising software code portions for performing the methods and/or processes as disclosed herein. The term “non-transitory” is used to exclude transitory, propagating signals, but to otherwise include any volatile or non-volatile computer memory technology suitable to the application. Additionally, or alternatively, the methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Unless otherwise specified, the terms ‘about’ and/or ‘close’ with respect to a magnitude or a numerical value may imply to be within an inclusive range of −10% to +10% of the respective magnitude or value.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not to be construed as excluding an embodiment referring to a condition “equal or below a threshold”. It is clear that should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

It should be understood that where the claims or specification refer to “a” or “an” element and/or feature, such reference is not to be construed as there being only one of that element. Hence, reference to “an element” or “at least one element” for instance may also encompass “one or more elements”.

As used herein the term “configuring” and/or ‘adapting’ for an objective, or a variation thereof, implies using materials and/or components in a manner designed for and/or implemented and/or operable or operative to achieve the objective.

Unless otherwise stated or applicable, the use of the expression “and/or” between the last two members of a list of options for selection indicates that a selection of one or more of the listed options is appropriate and may be made, and may be used interchangeably with the expressions “at least one of the following”, “any one of the following” or “one or more of the following”, followed by a listing of the various options.

As used herein, the phrase “A,B,C, or any combination of the aforesaid” should be interpreted as meaning all of the following: (i) A or B or C or any combination of A, B, and C, (ii) at least one of A, B, and C; and (iii) A, and/or B and/or C. This concept is illustrated for three elements (i.e., A,B,C), but extends to fewer and greater numbers of elements (e.g., A, B, C, D, etc.).

It is noted that the terms “operable to” or “operative to” can encompass the meaning of the term “adapted or configured to”. In other words, a machine “operable to” or “operative to” perform a task can in some embodiments, embrace a mere capability (e.g., “adapted”) to perform the function and, in some other embodiments, a machine that is actually made (e.g., “configured”) to perform the function.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 4, from 1 to 4, from 1 to 5, from 2 to 4, from 2 to 6, from 4 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It should be appreciated that combination of features disclosed in different embodiments are also included within the scope of the present inventions.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A resonant power conversion system comprising:
switching circuitry configured to convert a low frequency AC power signal to a high frequency AC power signal,
power conversion circuitry electrically connected in parallel with a source of the low frequency AC power signal and additionally connected in parallel with a consumer of the high frequency AC power signal,
wherein the source and the consumer are electrically connected in series; and
a low-pass filter serially connected between an output of the switching circuitry and the source of low frequency AC power signal.

2. The resonant power conversion system of claim 1, wherein the source of the low frequency AC power signal comprises a single-phase, two-phase or a three phase AC source.

3. The resonant power conversion system of claim 1 wherein the source of the low frequency AC power signal comprises an electric grid.

4. The resonant power conversion system of claim 1, wherein the consumer of the high frequency AP power signal comprises a resonant network.

5. (canceled)

6. The resonant power conversion system of claim 5 wherein the load comprises an electric vehicle battery.

7. The resonant power conversion system of claim 1, wherein the serial connection between the source and the consumer comprises a single-phase, two-phase, or a three-phase electrical connection.

8. The resonant power conversion system of claim 1, wherein the low-pass filter comprises an inductive filter.

9. The resonant power conversion system of claim 1, comprising a controller for controlling one or more parameter values relating to the resonant power conversion system.

10. The resonant power conversion system of claim 9, wherein the controlling is performed based on measured load-side parameter values.

11. (canceled)

12. A method of generating high frequency resonant AC power, the method comprising:
connecting switching circuitry configured to convert a low frequency AC power signal to a high frequency AC power signal in parallel with a source of the low frequency AC power signal;
connecting the switching circuitry in parallel with a consumer of the high frequency AC power signal;
connecting the source and the consumer in series; and
connecting a low-pass filter between an output of the switching circuitry and the source of low frequency AC power signal.

13. The method of claim 12, comprising using a three phase AC source as the source of the low frequency AC power signal.

14. The method of claim 12, comprising using an electric grid as the source of the low frequency AC power signal.

15. The method of claim 12, comprising using a resonant network as the consumer.

16. The method of claim 15 comprising connecting a load to the resonant network.

17. The method of claim 15, comprising using an electric vehicle battery as the load.

18. The method of claim 12, comprising connecting a three-phase electrical connection between the source and the consumer.

19. The method of claim 12, comprising connecting a two-phase electrical connection between the source and the consumer.

20. The method of claim 12, comprising connecting a single-phase electrical connection between the source and the consumer.

21. The method of claim 12, comprising using an inductive filter as the low-pass filter.

22. (canceled)

23. (canceled)

24. The method of claim 12, wherein the controlling is performed based on measured source-side parameter values.
